(19) United States
(12) Patent Application Publication
(10) Pub. No.: US 2007/0168548 A1
(43) Pub. Date: Jul. 19, 2007

(54) Method and system for performing multi-cluster application-specific routing

(75) Inventors: Oduomologhi Michael Atogi, Raleigh, NC (US); Brian Keith Martin, Cary, NC (US); Brian Keith Smith, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/334,874

(22) Filed: Jan. 19, 2006

(51) Int. Cl. G06F 15/173

(52) U.S. Cl. 709/238

(57) ABSTRACT

Computer implemented method, system and computer program product for routing an application in a data processing system that includes a plurality of machine clusters. A computer implemented method for routing an application request in a data processing system that includes a plurality of machine clusters includes receiving a request for running an application, and identifying at least one multi-cluster routing policy entry in a list of multi-cluster routing policy entries that matches the request. The application request is then routed to a machine cluster of the plurality of machine clusters in accordance with a policy of the matched at least one multi-cluster routing policy entry.

### BACKGROUND OF THE INVENTION

1. Field of the Invention

The present invention relates generally to the data processing field, and more particularly, to a computer implemented method, system and computer program product for routing an application request in a data processing system having multiple machine clusters.

2. Description of the Related Art

A single application may be served by more than one machine cluster in a data processing system that includes multiple clusters of machines. If one of the plurality of machine clusters is unavailable or over-utilized, it is known to send a request for the application to another machine cluster that is available or that is being utilized to a lesser extent.

Currently, when it is desired to send a request for an application from a first machine cluster to a second machine cluster, the request is directed to the second cluster using the URI (Universal Resource Identifier) of the second cluster. If the application is not available at the second cluster, or if the second cluster is otherwise unable to process the request, an error code is returned to the first cluster, and an attempt is then made to send the application from the first cluster to a third cluster. It may be necessary to repeat this process several times until a machine cluster is found that accepts the request. Current routing procedures, accordingly, do not provide a high degree of availability for application requests or permit efficient machine utilization.

There is, accordingly, a need for a mechanism for efficiently routing a request for an application in a data processing system that includes a plurality of machine clusters.

### BRIEF SUMMARY OF THE INVENTION

The present invention provides a computer implemented method, system and computer program product for routing an application request in a data processing system that includes a plurality of machine clusters. A computer implemented method for routing an application request in a data processing system that includes a plurality of machine clusters includes receiving a request for running an application, and identifying at least one multi-cluster routing policy entry in a list of multi-cluster routing policy entries that matches the request. The application request is then routed to a machine cluster of the plurality of machine clusters in accordance with a policy of the matched at least one multi-cluster routing policy entry. The present invention provides for a high degree of availability for application requests and improved machine utilization options.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which aspects of the present invention may be implemented;

FIG. 2 is a block diagram of a data processing system in which aspects of the present invention may be implemented;

FIG. 3 is a diagram that schematically illustrates an exemplary network topology that includes a mechanism for routing an application request in a data processing system having multiple machine clusters according to an exemplary embodiment of the present invention;

FIG. 4 is a diagram that schematically illustrates a further exemplary network topology that includes a mechanism for routing an application request in a data processing system having multiple machine clusters according to an exemplary embodiment of the present invention;

FIG. 5 is a flowchart that illustrates a method for routing an application request in a data processing system having multiple machine clusters according to an exemplary embodiment of the present invention; and

FIG. 6 is a flowchart that illustrates the routing step of FIG. 5 in greater detail.

### DETAILED DESCRIPTION OF THE INVENTION

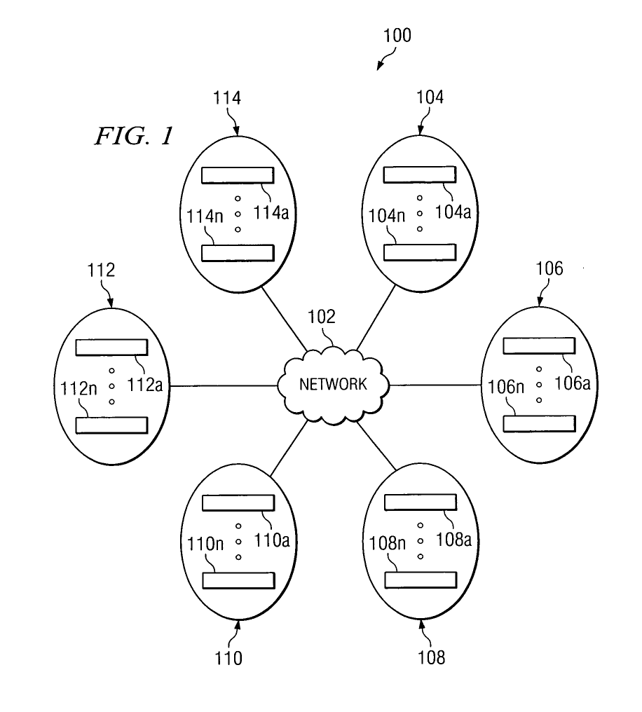

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a data processing system in which aspects of the present invention may be implemented. The data processing system is generally designated by reference number 100, and comprises a plurality of machine clusters 104-114 connected to one another through network 102. Network 102 is the medium used to provide communications links between the various clusters and other devices, and in the depicted example, comprises the Internet.

Each machine cluster 104-114 includes a plurality of application servers. For example, as shown in FIG. 1, cluster 104 includes a plurality of application servers 104a-104n, cluster 106 includes a plurality of application servers 106a-106n and so forth. It should be understood, however, that it is not intended to limit the invention to a data processing system having any particular number of machine clusters or to machine clusters containing any particular number of application servers. It should also be understood that machine clusters in the data processing system may have different numbers of application servers.

With reference now to FIG. 2, a block diagram of a data processing system is shown in which aspects of the present invention may be implemented. Data processing system 200 is an example of a computer, such as one of application servers 104a-104n in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

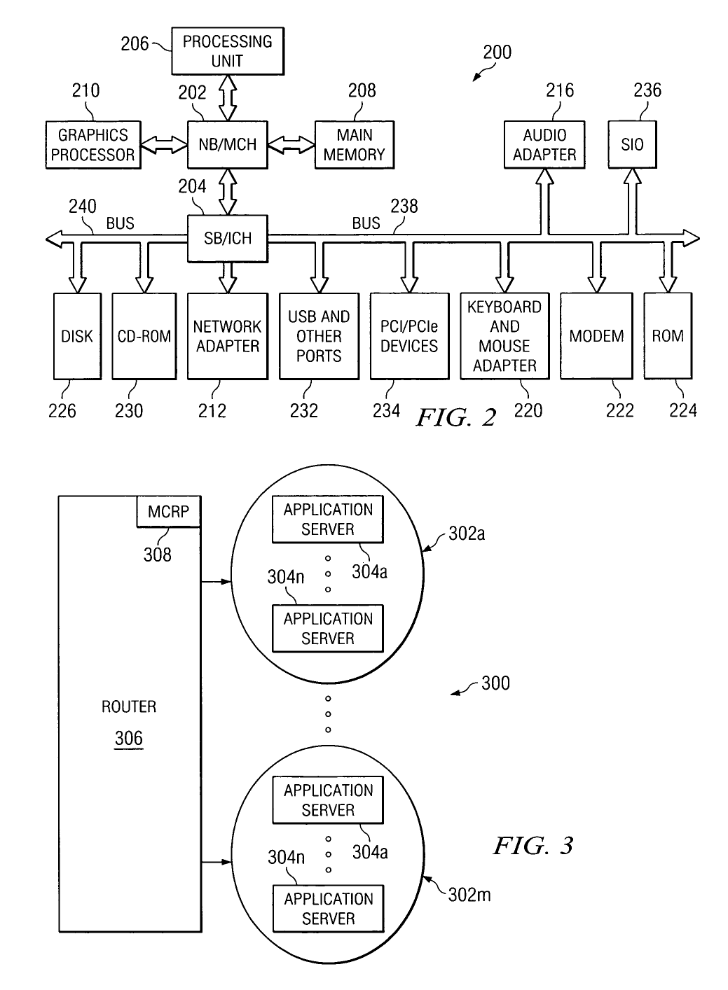

FIG. 3 is a diagram that schematically illustrates an exemplary network topology that includes a mechanism for routing an application request in a data processing system having multiple machine clusters according to an exemplary embodiment of the present invention. The topology is generally designated by reference number 300, and includes a plurality of machine clusters 302a-302m, each machine cluster, in turn, comprising a plurality of application servers 304a-304n, and a router 306.

Router 306 performs two levels of routing in topology 300: it first determines which cluster among machine clusters 302a-302m to route to; and then, which server among servers 304a-304n in the selected cluster to route to. In topology 300, all servers in all clusters are directly addressable from router 306.

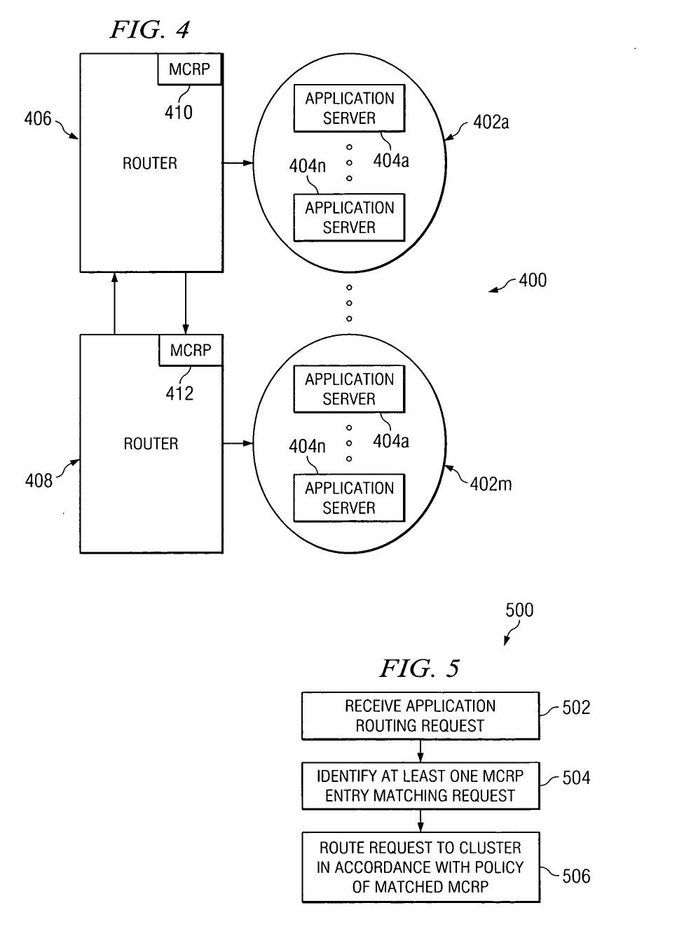

FIG. 4 is a diagram that schematically illustrates a further exemplary network topology that includes a mechanism for routing an application request in a data processing system having multiple machine clusters according to an exemplary embodiment of the present invention. The topology is generally designated by reference number 400, and comprises a topology that is commonly employed when machine clusters are geographically dispersed.

In topology 400, a different router is associated with each cluster. Thus, in FIG. 4, router 406 is associated with cluster 402a and router 408 is associated with cluster 402m, and other routers are associated with other clusters (not shown) in the data processing system. Router 406 can send a request directly to any of application servers 404a-404n in cluster 402a, and router 408 can send a request directly to any of servers 404a-404n in machine cluster 402m. Routers 406 and 408 can also send a request to each other, and, in this way, router 406 can indirectly send a request to cluster 402m and router 408 can indirectly send a request to cluster 402a (and to other clusters through their respective routers).

The present invention provides a mechanism for routing an application request in a data processing system having multiple clusters. The data processing system may be organized in one of topologies 300 or 400, in some combination of topologies 300 and 400, or in another manner. In accordance with the present invention, each router in the topology contains a list of Multi-Cluster Routing Policy (MCRP) entries which the router uses to route requests for applications in an application-specific manner to an appropriate machine cluster. Thus, router 306 in FIG. 3 includes MCRP list 308, and routers 406 and 408 in FIG. 4 include MCRP lists 410 and 412, respectively.

Each MCRP entry in an MCRP list contains an MCRP scope and an MCRP action. An MCRP scope specifies the requests to which the MCRP entry applies, and is of the following form:
[<cell>[:<application>[:module>]]]
where <cell> is the name of the administrative domain, <application> is the name of the application, and <module> is the name of the application module (for example, J2EE Web Module). If a particular request matches multiple MCRP entries in an MCRP list, the entry with the most specific scope is used first.

An MCRP action is of the following form:
<policy>@<cell>$<clusterOrRouter>[,<cell>$<clusterOr Router> . . . ]
where <policy> is the name of the policy, <cell> is the name of an administrative domain, and <clusterOrRouter> is the name of a cluster or router. The policy specifies whether the policy is a failover policy (wherein if a first cluster is not available, a second cluster is tried) or a load balancing policy (wherein routing is based on specified load balancing criteria). If the policy is a load balancing policy, the policy may also specify the particular load balancing algorithm to use.

Referring to FIG. 4 as an example, if router 406, associated with machine cluster 402a, receives a request that needs to be routed to a different machine cluster, and an MCRP match is found in MCRP list 410 with a failover policy, the request is routed to the first cluster or router that is marked-up as being a match (for example, to router 408 associated with cluster 402m). If a reply is received denoting that the application is not available at cluster 402m (e.g. HTTP error codes 503 (service unavailable) or 404 (not found)), then the request is routed to the next marked-up cluster or router in the list, and the first cluster or router is marked as being temporarily unavailable. A “flag” is associated with the request (e.g. for HTTP, a special HTTP request header) so that router 408 does not attempt to apply an additional MCRP policy in which the request is sent back to router 406 (and, hence, to cluster 402a).

If the MCRP policy is a load balancing policy, each cluster and/or router to which a router forwards a request is treated as a single server and has an associated weight. An appropriate load balancing algorithm is applied to select which cluster to route to. After the cluster has been selected, then the server within the cluster is selected. If the server level selection is based upon affinity (e.g. HTTP session affinity, WPF (WebSphere Partition Facility) affinity, etc.), a cluster level affinity is also applied so that subsequent requests are routed to the appropriate cluster and then to the correct server.

If affinity does not apply for a request, since clusters may be geographically dispersed and, therefore, have large latency differences, the “weighted least outstanding requests” algorithm in which the cluster with the fewest outstanding request count modulo a cluster weight is selected is generally preferred.

FIG. 5 is a flowchart that illustrates a method for routing an application request in a data processing system having multiple machine clusters according to an exemplary embodiment of the present invention. The method is generally designated by reference number 500, and begins by receiving a request for routing an application (Step 502). At least one MCRP entry in an MCRP list that matches the request is then identified (Step 504), and the application request is then routed to a machine cluster in accordance with the policy of a matched MCRP entry (Step 506). The request may be rotted to a machine cluster directly or indirectly through a router.

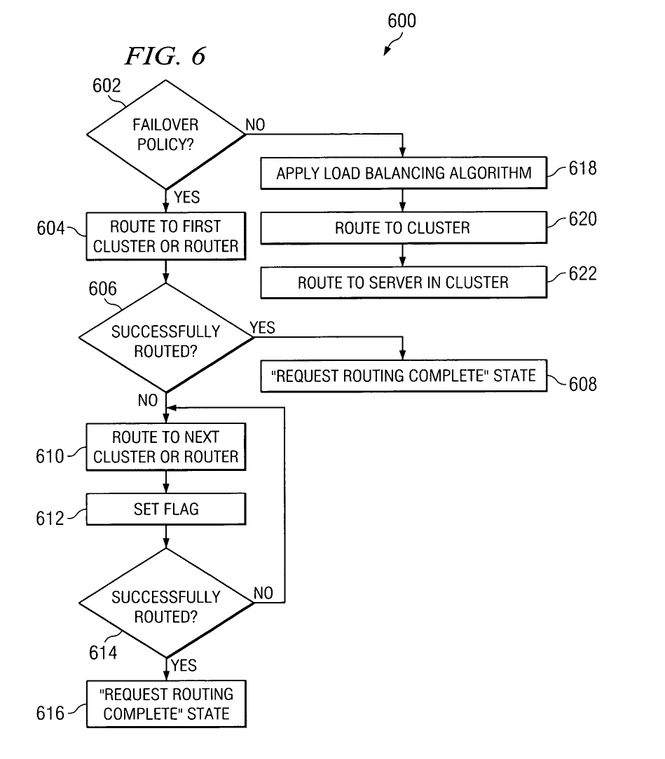

FIG. 6 is a flowchart that illustrates the routing step of FIG. 5 in greater detail. As shown in FIG. 6, it is first determined if the routing policy is a failover routing policy or a load balancing routing policy (Step 602). If the policy is a failover policy (Yes output of Step 602), the request is routed to the first listed cluster (directly or indirectly through a router) in the MCLP list that is marked up as being a match (step 604). A determination is then made whether the request has been successfully routed (Step 606). If the request has been successfully routed (Yes output of Step 606), a “request routing complete” state is achieved (Step 608). If the request has not been completed (No output of Step 606), a reply is returned and the request is routed to the next marked-up cluster (Step 610). A flag is also associated with the request (Step 612) to ensure that the request is not returned to the first cluster. A determination is then made whether the request was successfully routed to the next cluster (Step 614). If the request has been successfully routed (Yes output of Step 614), a “request routing complete” state is achieved (Step 616). If the request has not been successfully routed (No output of Step 614), the method returns to Step 610 to route the request to the next marked-up cluster in the list.

If the routing policy is a load balancing policy (No output of Step 602), an appropriate load balancing algorithm is applied to determine which cluster to route to (Step 618), and the request is routed to the identified cluster (Step 620) A determination is then made as to which server in the cluster to route to (Step 622).

The load balancing algorithm can be one in which server level selection is based on affinity, for example, HTTP session affinity, WPF affinity, etc. In such a case, a cluster level affinity is also applied so that subsequent requests will be routed to the correct cluster and then to the correct server. If affinity does not apply, it is preferred to use a “weighted least outstanding requests” algorithm in which the cluster with the fewest outstanding request count modulo a cluster weight is selected.

The present invention thus provides a computer implemented method, system and computer program product for routing an application in a data processing system that includes a plurality of machine clusters. A computer implemented method for routing an application request in a data processing system that includes a plurality of machine clusters includes receiving a request for running an application, and identifying at least one multi-cluster routing policy entry in a list of multi-cluster routing policy entries that matches the request. The application request is then routed to a machine cluster of the plurality of machine clusters in accordance with a policy of the matched at least one multi-cluster routing policy entry.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for routing an application request in a data processing system that includes a plurality of machine clusters, the computer implemented method comprising:
receiving a request for running an application;
identifying at least one multi-cluster routing policy entry in a list of multi-cluster routing policy entries that matches the request; and
routing the application request to a machine cluster of the plurality of machine clusters in accordance with a policy of the matched at least one multi-cluster routing policy entry.

2. The computer implemented method according to claim 1, wherein receiving a request for running an application, comprises:
receiving a request for running an application at a router.

3. The computer implemented method according to claim 1, wherein the multi-cluster routing policy entries each comprises a routing policy scope which specifies requests to which the routing policy applies, and a routing policy action which specifies a routing policy by which a request is to be routed, wherein the routing policy is one of a failover routing policy and a load-balancing routing policy.

4. The computer implemented method according to claim 3, wherein the routing policy is a failover routing policy, and wherein routing the application request to a machine cluster of the plurality of machine clusters in accordance with a policy of the matched at least one multi-cluster routing policy entry, comprises:
routing the application request to a first matched machine cluster in the list of multi-cluster routing policy entries.

5. The computer implemented method according to claim 4, and further comprising:
determining if a reply is received indicating that the first matched machine cluster is unable to process the application request; and
if the first matched machine cluster is unable to process the application request, routing the application request to a next matched machine cluster in the list of multi-cluster routing policy entries.

6. The computer implemented method according to claim 5, and further comprising:
setting a flag to prevent routing the application request back to the first-matched machine cluster.

7. The computer implemented method according to claim 3, wherein the routing policy is a load balancing policy, and wherein routing the application request to a machine cluster of the plurality of machine clusters in accordance with a policy of the matched at least one multi-cluster routing policy entry, comprises:
routing the application request to a selected machine cluster in accordance with an applied load balancing algorithm.

8. The computer implemented method according to claim 7, and further comprising:
routing the application request to a selected server in the selected machine cluster.

9. The computer implemented method according to claim 8, wherein the selected server is selected based on affinity.

10. A system for routing an application request in a data processing system that includes a plurality of machine clusters, comprising:
a multi-cluster routing policy list containing a plurality of multi-cluster routing policy entries; and
a router for routing an application request to a machine cluster of the plurality of machine clusters in accordance with a policy of at least one multi-cluster routing policy entry that matches the request.

11. The system according to claim 10, wherein the multi-cluster routing policy entries each comprises a routing policy scope which specifies requests to which the routing policy applies, and a routing policy action which specifies a routing policy by which a request is to be routed, wherein the routing policy is one of a failover routing policy and a load-balancing routing policy.

12. The system according to claim 11, wherein the routing policy is a failover routing policy, and wherein the router routes the application request to a first matched machine cluster in the list of multi-cluster routing policy entries.

13. The system according to claim 12, and further comprising:
a mechanism for determining if a reply is received indicating that the first matched machine cluster is unable to process the application request; and
if the first matched machine cluster is unable to process the application request, the router routing the request to a next matched machine cluster in the list of multi-cluster routing policy entries.

14. The system according to claim 13, and further comprising:
a mechanism for setting a flag to prevent routing the application request back to the first-matched machine cluster.

15. The system according to claim 11, wherein the routing policy is a load balancing policy, and wherein the router routes the request to a machine cluster in accordance with an applied load balancing algorithm.

16. A computer program product, comprising:
a computer usable medium for routing an application request in a data processing system that includes a plurality of machine clusters, the computer program product comprising:
computer usable program code configured for receiving a request for running an application;
computer usable program code configured for identifying at least one multi-cluster routing policy entry in a list of multi-cluster routing policy entries that matches the request; and
computer usable program code configured for routing the application request to a machine cluster of the plurality of machine clusters in accordance with a policy of the matched at least one multi-cluster routing policy entry.

17. The computer program product according to claim 16, wherein the policy comprises a failover routing policy, and wherein the computer usable program code configured for routing the application request to a machine cluster in accordance with a policy of the matched at least one multi-cluster routing policy entry, comprises:
computer usable program code configured for routing the application request to a first matched machine cluster in the list of multi-cluster routing policy entries.

18. The computer program product according to claim 17, and further comprising:
computer usable program code configured for determining if a reply is received indicating that the first matched machine cluster is unable to process the application request; and
if the first matched machine cluster is unable to process the application request, computer usable program code configured for routing the application request to a next matched machine cluster in the list of multi-cluster routing policy entries.

19. The computer program product according to claim 18, and further comprising:
computer usable program code configured for setting a flag to prevent routing the application request back to the first-matched machine cluster.

20. The computer program product according to claim 16, wherein the policy comprises a load balancing policy, and wherein the computer usable program code configured for routing the application request to a machine cluster in accordance with a policy of the matched at least one multi-cluster routing policy entry, comprises:
computer usable program code configured for routing the application request to a machine cluster in accordance with an applied load balancing algorithm.
